(19) United States
(12) Patent Application Publication
(10) Pub. No.: US 2023/0268731 A1
(43) Pub. Date: Aug. 24, 2023

(54) ELECTROSTATIC BREAKDOWN PROTECTION CIRCUIT AND CAPACITANCE SENSOR DEVICE

(71) Applicant: LAPIS Technology Co., Ltd., Yokohama (JP)

(72) Inventors: Masayuki Otsuka, Yokohama (JP); Satoru KUROTSU, Yokohama (JP)

(73) Assignee: LAPIS Technology Co., Ltd., Yokohama (JP)

(21) Appl. No.: 18/170,552

(22) Filed: Feb. 17, 2023

(30) Foreign Application Priority Data
Feb. 24, 2022 (JP) 2022-027053

(51) Int. Cl. H02H 9/04; G01K 7/34; G01K 1/08

(52) U.S. Cl. CPC H02H 9/04; G01K 1/08; G01K 7/343

(57) ABSTRACT

An electrostatic breakdown protection circuit and a capacitance sensor device are provided. An electrostatic breakdown protection circuit included in an electronic device including an external terminal and an internal circuit connected to the external terminal includes: a first series diode group in which n diodes including a first diode having an anode connected to the external terminal and a second diode having a cathode applied with a power supply voltage are connected in series; and a second series diode group in which n diodes including a third diode having a cathode connected to the external terminal and a fourth diode having an anode applied with a ground voltage are connected in series.

### CROSS-REFERENCE TO RELATED APPLICATION

This application claims the priority benefit of Japan Application Serial No. 2022-027053, filed on Feb. 24, 2022. The entirety of the above-mentioned patent application is hereby incorporated by reference herein and made a part of this specification.

### BACKGROUND

### Technical Field

The disclosure relates to an electrostatic breakdown protection circuit and a capacitance sensor device that detects changes in capacitance of a capacitor.

### Description of Related Art

An IC tag that has a function of detecting a history of changes in ambient temperature to which an article is exposed during transportation or storage and wirelessly transmitting the detected information has been proposed (for example, Japanese Patent Application Laid-Open No. 2007-333484).

A capacitance sensor for detecting changes in ambient temperature is externally attached to the IC tag and the capacitance sensor includes a capacitor which is filled between electrodes with a lump of wax as a dielectric and an absorber which absorbs a liquid wax when the lump of wax is liquefied. In the capacitance sensor, when the ambient temperature reaches the melting point of the wax, the wax filled between the electrodes of the capacitor is liquefied and absorbed by the absorber. Accordingly, an area sandwiched between the electrodes of the capacitor is filled with air.

At this time, since the dielectric constant of air is smaller than that of wax, the capacitance of the capacitor decreases and the impedance increases. Here, such an IC tag is provided with a capacitance sensor circuit which detects the impedance as the capacitance of the capacitor, a communication circuit which transmits the detection result by short-range wireless communication, and an external terminal which externally connects the capacitor thereto.

Further, a semiconductor IC chip such as the IC tag is provided with an ESD protection circuit which prevents a large current caused by electrostatic discharge (hereinafter referred to as ESD) generated outside the chip from flowing into an internal circuit via a power supply terminal (for example, see Japanese Patent Application Laid-Open No. 2003-72076).

The ESD protection circuit has a configuration in which a resistor and first and second diodes below are connected to an electrode pad connected to an external terminal of the semiconductor IC chip by wire bonding or the like. That is, in the first diode, an anode is connected to an electrode pad and a cathode is applied with a power supply voltage. In the second diode, an anode is applied with a ground voltage and a cathode is connected to the electrode pad. In the resistor, one end is connected to the electrode pad and another end is connected to the internal circuit. According to such an ESD protection circuit, even when a surge voltage accompanying electrostatic discharge is applied to the electrode pad via the external terminal of the semiconductor IC chip, the surge voltage is clamped to [power supply voltage+forward voltage of diode] or [ground voltage-forward voltage of diode] by the ESD protection circuit.

Thus, the ESD protection circuit protects the internal circuit from a surge voltage serving as a high voltage and accompanying electrostatic discharge.

The IC tag uses electromagnetic waves wirelessly transmitted at short distances from a communication terminal called a reader/writer to obtain a power supply voltage to operate itself (wireless power supply), and performs wireless communication with the reader/writer. Incidentally, since the IC tag receives electromagnetic waves from a reader/writer at a short distance, there is a risk that electromagnetic wave noise may enter the electrode pad via the external terminal of the IC tag.

Here, when the ESD protection circuit described in Japanese Patent Application Laid-Open No. 2003-72076 is provided in such an electrode pad, a current accompanying the electromagnetic wave noise flows into the first or second diode of the ESD protection circuit. Accordingly, a charge corresponding to the difference between a forward current flowing into the first diode and a forward current flowing into the second diode is accumulated in the electrode pad.

Thus, when the capacitor serving as a capacitance element described in Japanese Patent Application Laid-Open No. 2007-333484 is externally attached to the external terminal connected to the electrode pad, charges accompanying the electromagnetic wave noise are accumulated as initial charges in the capacitor.

Thus, since the initial charge amount of the capacitor deviates from the specified initial charge amount, an error may occur in the output result of the internal circuit connected to the capacitor. For example, if the internal circuit is the capacitance sensor circuit described in Japanese Patent Application Laid-Open No. 2007-333484, an error occurs in the capacitance detection result of the capacitor by the capacitance sensor circuit.

### SUMMARY

According to an embodiment, an electrostatic breakdown protection circuit of the disclosure is an electrostatic breakdown protection circuit included in an electronic device including an external terminal and an internal circuit connected to the external terminal, including: a first series diode group in which n (where n is an integer equal to or larger than 2) number of diodes including a first diode having an anode connected to the external terminal and a second diode having a cathode applied with a power supply voltage are connected in series; and a second series diode group in which n diodes including a third diode having a cathode connected to the external terminal and a fourth diode having an anode applied with a ground voltage are connected in series.

According to another embodiment, a capacitance sensor device of the disclosure is a capacitance sensor device including: a sensor capacitor of which a capacitance changes according to changes in the environment; a first external terminal to which an electrode of the sensor capacitor is externally attached; a first electrostatic breakdown protection circuit which is connected to the first external terminal; a first capacitance circuit which has a first reference capacitance; and a determination circuit which includes a first and second relay terminals, supplies a charging current from the first relay terminal to the sensor capacitor via the first electrostatic breakdown protection circuit and the first external terminal, supplies a charging current from the second relay terminal to the first capacitance circuit, and then compares a magnitude of a potential of the first relay terminal with a magnitude of a potential of the second relay terminal to detect the capacitance of the sensor capacitor or detect whether there is a change in the capacitance of the sensor capacitor, wherein the first electrostatic breakdown protection circuit includes a first diode of which an anode is connected to the first external terminal, a second diode of which a cathode receives a power supply voltage and an anode is connected to a cathode of the first diode, a third diode of which a cathode is connected to the first external terminal, and a fourth diode of which an anode receives a ground voltage and a cathode is connected to an anode of the third diode.

According to the embodiments of the disclosure, in the electrostatic breakdown protection circuit that protects the internal circuit from electrostatic breakdown by causing a current entering via the external terminal of the electronic device due to electrostatic discharge to flow into the power supply line or the ground line, it is possible to increase the threshold voltage at which the current starts to flow. Accordingly, it is possible to prevent the current accompanying electromagnetic wave noise from flowing via the external terminal to the power supply line or the ground line.

Thus, since charges accompanying electromagnetic wave noise are suppressed from being accumulated in the external terminal when electromagnetic wave noise is received from the outside, it is possible to suppress an output error of the internal circuit operating according to the signal of the external terminal. For example, since the electrostatic breakdown protection circuit according to the disclosure is adopted in the capacitance sensor device that detects the capacitance of the capacitor externally attached to the external terminal or changes in the capacitance, it is possible to suppress fluctuations in the initial charge amount of the capacitor due to electromagnetic wave noise and hence to suppress the detection error of the capacitance sensor device.

### BRIEF DESCRIPTION OF THE DRAWINGS

FIG. 1 is a circuit diagram illustrating a configuration of an electrostatic breakdown protection circuit 10 connected to an electrode pad PAD of a semiconductor IC chip.

FIG. 2 is a diagram illustrating an example of a waveform of electromagnetic wave noise NZ applied to an electrode pad PAD.

FIG. 3 is a circuit diagram illustrating a configuration of the electrostatic breakdown protection circuit 10 when diodes DA1, DA2, DB1, and DB2 are composed of MOS transistors.

FIG. 4 is a circuit diagram illustrating a configuration of an electrostatic breakdown protection circuit 10a as another example of the electrostatic breakdown protection circuit 10.

FIG. 5 is a perspective view illustrating an appearance of a sensor tag 150 equipped with a capacitance sensor device including an electrostatic breakdown protection circuit according to the disclosure.

FIG. 6 is a plan view of a device formed on a surface of a substrate 110 when viewed through a protection plate 120 of the sensor tag 150.

FIG. 7 is a diagram illustrating a form of wireless communication between the sensor tag 150 and a reader/writer 200.

FIG. 8 is a block diagram illustrating a configuration of a circuit formed on an IC chip 100.

FIG. 9 is a block diagram illustrating a configuration of a capacitance sensor circuit 15.

FIG. 10 is a diagram illustrating an operation of a switching circuit SW.

FIG. 11 is a circuit diagram illustrating a configuration of a determination circuit JC.

FIG. 12 is a block diagram describing an internal state of the capacitance sensor circuit 15 when a sensor capacitor 50 is connected to electrode pads P0 and P2.

FIG. 13 is a block diagram describing an internal state of the capacitance sensor circuit 15 when the sensor capacitor 50 is connected to electrode pads P3 and P2.

FIG. 14 is an equivalent circuit diagram of a circuit included between the electrode pad P2 and an input terminal CIN0M2 of the switching circuit SW.

FIG. 15 is a block diagram describing an internal state of the capacitance sensor circuit 15 in a test mode.

### DESCRIPTION OF THE EMBODIMENTS

Here, embodiments of the disclosure provide an electrostatic breakdown protection circuit and a capacitance sensor device capable of protecting an internal circuit from electrostatic discharge and reducing an output error of the internal circuit due to external electromagnetic wave noise.

Hereinafter, embodiments of the disclosure will be described in detail with reference to the drawings.

### First Embodiment

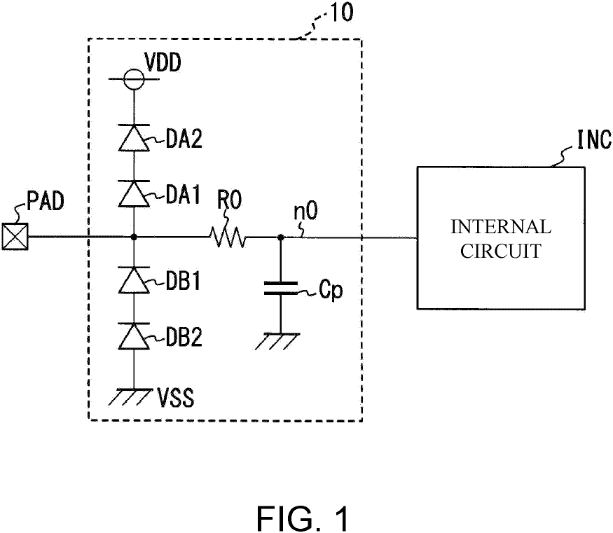

FIG. 1 is a circuit diagram illustrating a configuration of an electrostatic breakdown protection circuit 10 connected to an electrode pad PAD when the electrode pad PAD is extracted as one external terminal from a plurality of external terminals of a semiconductor IC chip.

As illustrated in FIG. 1, the electrostatic breakdown protection circuit 10 includes diodes DA1, DA2, DB1, and DB2, a resistor R0, and a capacitor Cp.

The anode of the diode DA1, the cathode of the diode DB1, and one end of the resistor R0 are connected to the electrode pad PAD. The anode of the diode DA2 is connected to the cathode of the diode DA1 and the cathode of the diode DA2 is applied with a power supply voltage VDD via a power supply line. The cathode of the diode DB2 is connected to the anode of the diode DB1 and the anode of the diode DB2 is applied with a ground voltage VSS via a ground line. Another end of the resistor R0 is connected to an internal circuit INC formed on the semiconductor IC chip via a node n0. One electrode of both electrodes of the capacitor Cp is connected to the node n0 and another electrode of the capacitor Cp is applied with the ground voltage VSS.

In addition, when the diodes DA1, DA2, DB1, and DB2 are formed on the p-type or n-type semiconductor substrate of the semiconductor IC chip, the diodes DA1, DA2, DB1 and DB2 are formed on separate substrates.

By the configuration illustrated in FIG. 1, in the electrostatic breakdown protection circuit 10, even if a surge voltage accompanying electrostatic discharge is applied to the electrode pad PAD, the surge voltage is clamped to a voltage less than a positive threshold voltage Vth1 represented by Vth1=power supply voltage VDD+(forward voltage of diodes DA1 and DA2 in series) and higher than a negative threshold voltage Vth2 represented by Vth2=ground voltage-(forward voltage of diodes DB1 and DB2 in series).

Accordingly, a current corresponding to the surge voltage exceeding the threshold voltage flows into the power supply line (ground line) via the diodes DA1 and DA2 (DB1 and DB2). In addition, a part of the current flows into the internal circuit INC via the resistor R0 and the node n0 due to the electrostatic discharge, but the amount of current is attenuated by passing through an integrating circuit composed of the resistor R0 and the capacitor Cp.

Thus, the electrostatic breakdown protection circuit 10 protects the internal circuit INC from a high surge voltage accompanying electrostatic discharge.

Incidentally, when the semiconductor IC chip including the electrostatic breakdown protection circuit 10 is brought close to a communication device conforming to a short-range wireless communication standard, for example, ISO/IEC18000-6 Type-C, electromagnetic wave noise emitted from the communication device is applied to the electrode pad PAD.

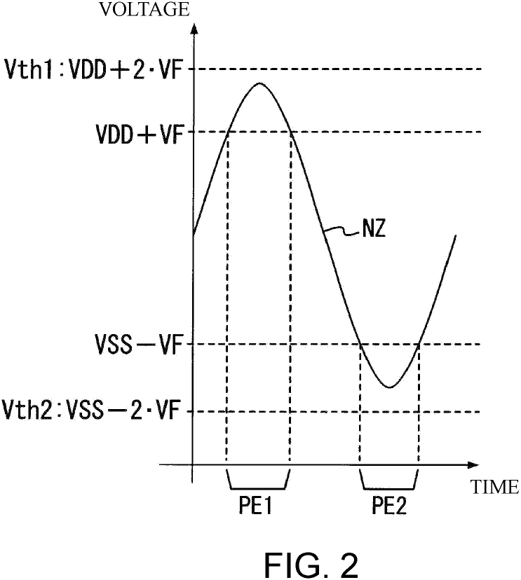

FIG. 2 is a diagram illustrating an example of a waveform of electromagnetic wave noise NZ applied to the electrode pad PAD.

Here, it is assumed that the diode DA1 is the only diode connected between the electrode pad PAD and the power supply voltage VDD and the diode DB1 is the only diode connected between the electrode pad PAD and the ground voltage VSS. Further, it is assumed that the forward voltage of each of the diodes DA1, DA2, DB1, and DB2 is a common forward voltage VF.

At this time, in an example illustrated in FIG. 2, since the voltage value of the electromagnetic wave noise NZ exceeds the positive threshold voltage (VF+VDD) over the period PE1, the diode DA1 is turned on and a current flows from the electrode pad PAD to the power supply line via the diode DA1 during this time.

Furthermore, as illustrated in FIG. 2, since the voltage value of the electromagnetic wave noise NZ is below the negative threshold voltage (VSS-VF) over the period PE2, the diode DB1 is turned on and a current flows from the ground line to the electrode pad PAD via the diode DB1 during this time.

Accordingly, a charge corresponding to the difference between the forward current flowing into the diode DA1 and the forward current flowing into the diode DB1 is accumulated in the electrode pad PAD.

Thus, when a capacitance element such as a capacitor is externally attached to the external terminal of the semiconductor IC chip connected to the electrode pad PAD, a charge accompanying the electromagnetic wave noise is accumulated in this capacitor.

Thus, if the amount of charge stored in the capacitor fluctuates with respect to the desired amount of charge and this fluctuation affects the operation of the internal circuit INC, there was a possibility that an error would occur in the output of the internal circuit INC.

In contrast, in the electrostatic breakdown protection circuit 10, as illustrated in FIG. 1, the positive threshold voltage is set to the following threshold voltage Vth1 higher than the threshold voltage (VDD+VF) and represented by Vth1=VDD+2•VF by connecting the diode DA2 to the diode DA1 in series.

Furthermore, in the electrostatic breakdown protection circuit 10, as illustrated in FIG. 1, the negative threshold voltage is set to the following threshold voltage Vth2 lower than the threshold voltage (VSS-VF) and represented by Vth2=VSS-2•VF by connecting the diode DB2 to the diode DB1 in series.

Accordingly, as illustrated in FIG. 2, the positive threshold voltage (=VDD+2•VF) at which the diode (DA1, DA2) is turned on can be made higher than the positive peak voltage value of the electromagnetic wave noise NZ. Further, as illustrated in FIG. 2, the negative threshold voltage (=VSS-2•VF) at which the diode (DB1, DB2) is turned on can be made lower than the negative peak voltage value of the electromagnetic wave noise NZ.

Thus, no current flows between the electrode pad PAD and the power supply line (or the ground line) even if the electromagnetic wave noise emitted from the communication device at a close position is applied to the electrode pad PAD. Accordingly, since the charge accompanying electromagnetic wave noise is not accumulated in the electrode pad PAD, the charge amount of the capacitor does not fluctuate even if a capacitance element such as a capacitor is externally attached to the electrode pad PAD. Thus, when the electrode pad PAD receives electromagnetic wave noise, it is possible to suppress the output error of the internal circuit INC that operates according to the signal corresponding to the charge amount of the external capacitor.

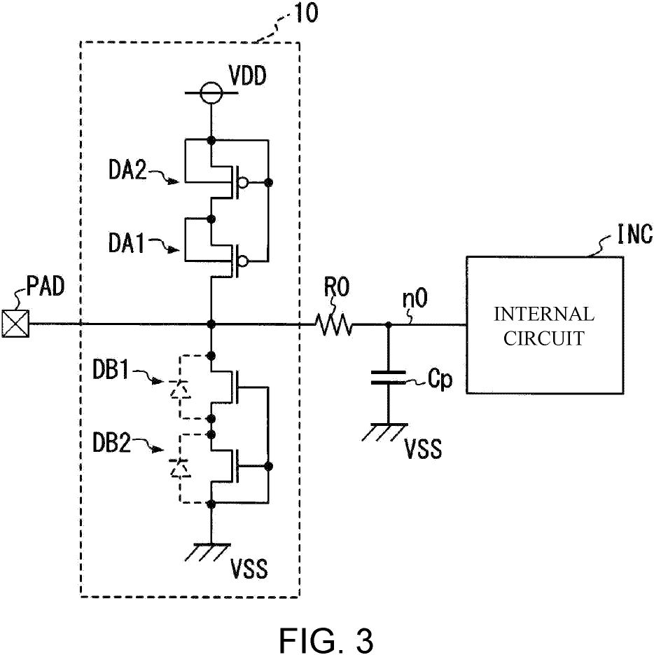

In addition, the diodes DA1, DA2, DB1, and DB2 of the electrostatic breakdown protection circuit 10 may be realized by MOS transistors as illustrated in FIG. 3.

As illustrated in FIG. 3, the diode DA1 is composed of a P-channel MOS transistor of which a source is connected to the electrode pad PAD, a drain is connected to the back gate, and a gate is applied with the power supply voltage VDD.

The diode DA2 is composed of a P-channel MOS transistor of which a source is connected to the drain of the diode DA1, a drain is connected to the back gate, and a drain and a gate are applied with the power supply voltage VDD. The diode DB1 is composed of an N-channel MOS transistor of which a source is connected to the electrode pad PAD and a gate is applied with the ground voltage VSS. The diode DB2 is composed of an N-channel MOS transistor of which a source is connected to the drain of the diode DB1 and a drain and a gate are applied with the ground voltage VSS.

In addition, in an example illustrated in FIG. 3, the diodes DA1 and DA2 are P-channel MOS transistors and the diodes DB1 and DB2 are N-channel MOS transistors, but all diodes (DA1, DA2, DB1, DB2) may be realized by the same conductive MOS transistors. At this time, when the N-channel MOS transistors are used as the diodes, the transistors are respectively formed on the separate semiconductor substrates. Then, when the P-channel MOS transistors are used as the diodes, the transistors are respectively formed in independent well regions.

Further, the diode (DA1, DA2, DB1, DB2) of the electrostatic breakdown protection circuit 10 may be a combination of the diode or MOS transistor formed in an isolated region of the semiconductor substrate and the diode or MOS transistor formed in a non-isolated region.

Further, in the embodiment illustrated in FIGS. 1 or 2, the positive diode (DA1, DA2) and the negative diode (DB1, DB2) are each connected in series to two stages, but the number of series stages may be three or more.

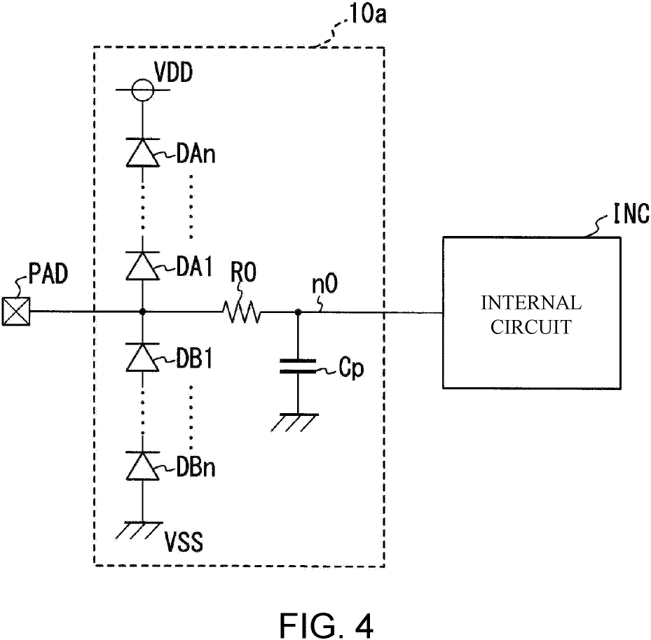

FIG. 4 is a circuit diagram illustrating a configuration of an electrostatic breakdown protection circuit 10a as another example of the electrostatic breakdown protection circuit 10 which has been made in view of this point.

As illustrated in FIG. 4, the electrostatic breakdown protection circuit 10a includes diodes DA1 to DAn (where n is an integer equal to or larger than 2) connected in series between the power supply line and the electrode pad PAD and diodes DB1 to DBn connected in series between the electrode pad PAD and the ground line together with the resistor R0 and the capacitor Cp.

According to the electrostatic breakdown protection circuit 10a illustrated in FIG. 4, the positive threshold voltage Vth1 clamping electromagnetic wave noise is represented by Vth1 = VDD+n•VF (where n: an integer equal to or larger than 2 and VF: a forward voltage of each of diodes DA1 to DAn) and the negative threshold voltage Vth2 is represented by Vth2 = VSS-n•VF (n: an integer equal to or larger than 2 and VF: a forward voltage of each of diodes DB1 to DBn).

Here, the number n of series stages of the diodes DA1 to DAn (DB1 to DBn) is determined so that the threshold voltage Vth1 is higher than the positive peak voltage of the assumed electromagnetic wave noise NZ and the threshold voltage Vth2 is lower than the negative peak voltage of the electromagnetic wave noise NZ.

That is, a threshold voltage at which the diodes DA1 to DAn (DB1 to DBn) start flowing a current accompanying the electromagnetic wave noise NZ toward the power supply line or the ground line is determined by the number of stages of the diodes in series.

Accordingly, the electrostatic breakdown protection circuit 10a can protect the internal circuit INC from electrostatic discharge and prevent a current accompanying electromagnetic wave noise from flowing to the power supply line or the ground line when the electromagnetic wave noise is received in the case of the assumed electromagnetic wave noise. Thus, since the charge accompanying the current is prevented from being accumulated in the external terminal (PAD), the output error of the internal circuit INC that operates according to the signal of the external terminal is suppressed.

In short, as the electrostatic breakdown protection circuit (10, 10a) according to the disclosure, the electrostatic breakdown protection circuit may include a first series diode group (DA1 to DAn) in which n (n is an integer equal to or larger than 2) number of diodes including a first diode (DA1) of which an anode is connected to the external terminal (PAD) and a second diode (DA2 or DAn) of which a cathode is applied with the power supply voltage (VDD) are connected in series and a second series diode group (DB1 to DBn) in which n diodes including a third diode (DB1) of which a cathode is connected to the external terminal (PAD) and a fourth diode (DB2 or DBn) of which an anode is applied with the ground voltage (VSS) are connected in series.

### Second Embodiment

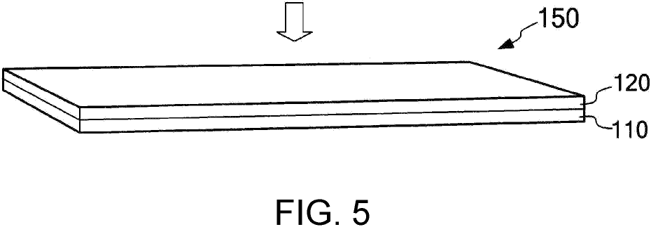

FIG. 5 is a perspective view illustrating an appearance of a sensor tag 150 equipped with a semiconductor IC chip including an electrostatic breakdown protection circuit according to the disclosure. In addition, the sensor tag 150 is, for example, a passive RFID (Radio Frequency Identification) IC tag having a function of detecting whether or not the sensor tag has been exposed to an ambient temperature higher than a predetermined temperature and wirelessly transmitting that effect.

The sensor tag 150 includes a substrate 110 in which a plurality of devices is formed on one surface and a protection plate 120 attached to one surface of the substrate 110 to cover the plurality of devices. In addition, the substrate 110 and the protection plate 120 are, for example, flexible substrates of PET (polyethylene terephthalate) or the like.

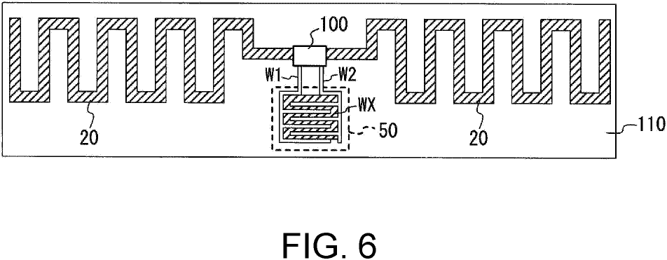

FIG. 6 is a plan view of the device formed on the surface of the substrate 110 when viewed through the protection plate 120 of the sensor tag 150 from the direction of the white arrow illustrated in FIG. 5.

As illustrated in FIG. 6, devices such as an IC (Integrated Circuit) chip 100, an antenna 20, and a sensor capacitor 50 are formed on one surface of the substrate 110.

The antenna 20 is made of, for example, a conductive wiring material, and is connected to an electrode pad of the IC chip 100 as a semiconductor device.

The sensor capacitor 50 has a structure in which its capacitance changes irreversibly depending on the ambient temperature and functions as a temperature sensor that detects changes in ambient temperature based on changes in the capacitance.

For example, as illustrated in FIG. 6, the sensor capacitor 50 includes comb-shaped electrodes W1 and W2 which are arranged along one surface of the substrate 110 and wax WX filled between the comb teeth of the electrodes W1 and W2. In addition, the electrodes W1 and W2 are electrodes having a comb-shaped planar pattern arranged opposite to each other so that the comb teeth are alternately arranged side by side. The wax WX serves as the dielectric of the capacitor. The wax WX remains in a solid state when the ambient temperature is below its melting point and liquefies when the ambient temperature rises above its melting point. Thus, when the sensor capacitor 50 is exposed to an ambient temperature higher than the melting point, the wax WX as the dielectric liquefies and flows out from between the electrodes W1 and W2, and the capacitance of the sensor capacitor 50 is decreased.

Accordingly, the sensor capacitor 50 as the temperature sensor has a predetermined first capacitance when the ambient temperature is below a predetermined temperature (melting point of wax) and changes to a second capacitance lower than the first capacitance when the ambient temperature becomes higher than the predetermined temperature. After that, even if the ambient temperature returns to the melting point or lower of the wax WX, the wax WX that has flowed out does not return, so the sensor capacitor 50 maintains the state of the second capacitance described above.

One end of each of the electrodes W1 and W2 of the sensor capacitor 50 is connected to an electrode pad (described later) as an external terminal of the IC chip 100, respectively.

The IC chip 100 included in the sensor tag 150 is provided with a capacitance sensor circuit that detects changes in the capacitance of the sensor capacitor 50 or the capacitance itself and a communication circuit that uses the antenna 20 to perform short-range wireless communication conforming to, for example, ISO/IEC18000-6 Type-C.

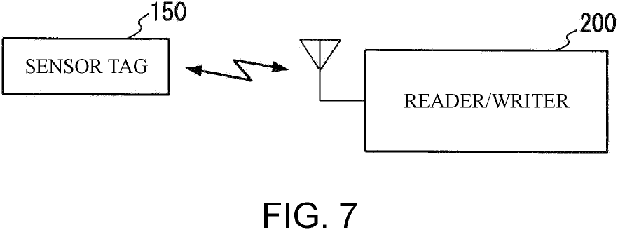

For example, as illustrated in FIG. 7, when the sensor tag 150 is brought close to a reader/writer 200, the reader/writer 200 transmits radio waves for power supply in accordance with ISO/IEC18000-6 Type-C, which is a short-range wireless communication standard. Then, the communication circuit included in the IC chip 100 of the sensor tag 150 receives the radio waves for power supply via the antenna 20 and generates a power supply voltage for operating itself based on the radio waves. Accordingly, the capacitance sensor circuit included in the IC chip 100 detects the capacitance of the sensor capacitor 50 and the communication circuit wirelessly sends various information based on the capacitance detected together with its identification ID or information indicating the capacitance itself to the reader/writer 200 via the antenna 20 in accordance with ISO/IEC18000-6 Type-C.

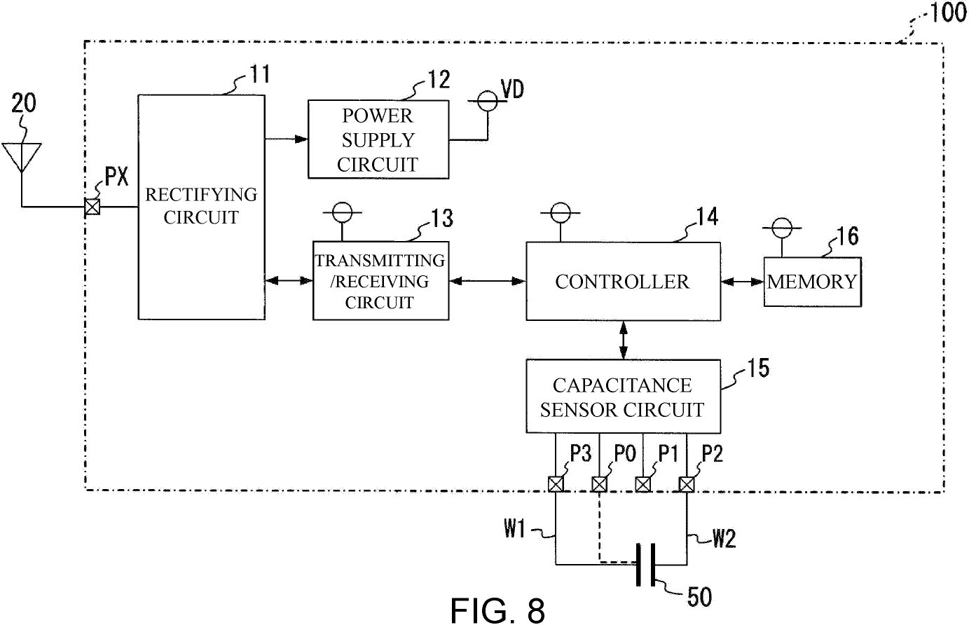

FIG. 8 is a block diagram illustrating a configuration of a circuit formed on the IC chip 100.

As illustrated in FIG. 8, the IC chip 100 is provided with a rectifying circuit 11, a power supply circuit 12, a transmitting/receiving circuit 13, a controller 14, a nonvolatile memory 16 storing its identification ID and a capacitance sensor circuit 15.

The antenna 20 is connected to the rectifying circuit 11 via an electrode pad PX. The antenna 20 receives radio waves from the reader/writer 200, a high-frequency signal indicating received information (including a command code) and a high-frequency current for wireless power supply via the electrode pads PX, and supplies them to the rectifying circuit 11.

The rectifying circuit 11 supplies a DC voltage obtained by rectifying a high-frequency current to the power supply circuit 12, and supplies a signal obtained by rectifying and detecting the high-frequency signal to the transmitting/receiving circuit 13 as a receiving signal. Further, the rectifying circuit 11 supplies the modulated signal supplied from the transmitting/receiving circuit 13 to the antenna 20.

The power supply circuit 12 generates a power supply voltage VDD having a constant voltage value based on the DC voltage supplied from the rectifying circuit 11 and supplies the power supply voltage to the transmitting/receiving circuit 13, the controller 14, the memory 16, and the capacitance sensor circuit 15. By receiving such a power supply voltage VDD, each of the transmitting/receiving circuit 13, the controller 14, the memory 16, and the capacitance sensor circuit 15 performs the following operation.

The transmitting/receiving circuit 13 acquires a command code by demodulating the received signal supplied from the rectifying circuit 11 and supplies the command code to the controller 14. Further, the transmitting/receiving circuit 13 supplies a modulated signal obtained by modulating a carrier wave signal corresponding to, for example, the UHF band, HF (High Frequency) band, or LF (Low Frequency) band according to the above-described short-range wireless communication standard with transmission information supplied from the controller 14 to the rectifying circuit 11.

The controller 14 reads the identification ID stored in the memory 16 and acquires the identification ID.

Furthermore, the controller 14 supplies various control signals for detecting the capacitance of the sensor capacitor 50 externally connected to the IC chip 100 to the capacitance sensor circuit 15.

Here, the capacitance sensor circuit 15 compares the capacitance of the sensor capacitor 50 with the reference capacitance in response to these various control signals. Then, the capacitance sensor circuit 15 determines whether or not the capacitance of the sensor capacitor 50 has changed from a first capacitance to a second capacitance lower than the first capacitance based on the comparison result. The capacitance sensor circuit 15 supplies this determination result to the controller 14.

The controller 14 generates temperature change information indicating whether or not the sensor tag 150 has been exposed to an ambient temperature higher than a predetermined temperature based on the determination result and supplies information including the temperature change information and its identification ID to the transmitting/receiving circuit 13 as the transmission information described above.

Accordingly, the sensor tag 150 wirelessly sends the identification ID and the temperature change information indicating whether or not the sensor tag has a history of exposure to the ambient temperature higher than a predetermined temperature to the reader/writer 200 illustrated in FIG. 7.

Hereinafter, the configuration of the capacitance sensor circuit 15 will be described in detail.

As illustrated in FIG. 8, the capacitance sensor circuit 15 is connected to electrode pads P0 to P3 as the external terminals of the IC chip 100. The electrode pads P0 to P3 are so-called bonding pads and all of them have the same parasitic capacitance.

Here, P0 and P3 of the electrode pads P0 to P3 are electrode pads for externally connecting the electrode W1 which is one of the electrodes W1 and W2 of the sensor capacitor 50 described above. Further, the electrode pad P2 is an electrode pad for externally connecting another electrode W2 of the electrodes W1 and W2 of the sensor capacitor 50.

In addition, the electrode pad P0 is an electrode pad for connecting the electrode W1 of the sensor capacitor 50 when the capacitance of the sensor capacitor 50 is relatively small. On the other hand, the electrode pad P3 is an electrode pad for connecting the electrode W1 of the sensor capacitor 50 when the capacitance of the sensor capacitor 50 is relatively large.

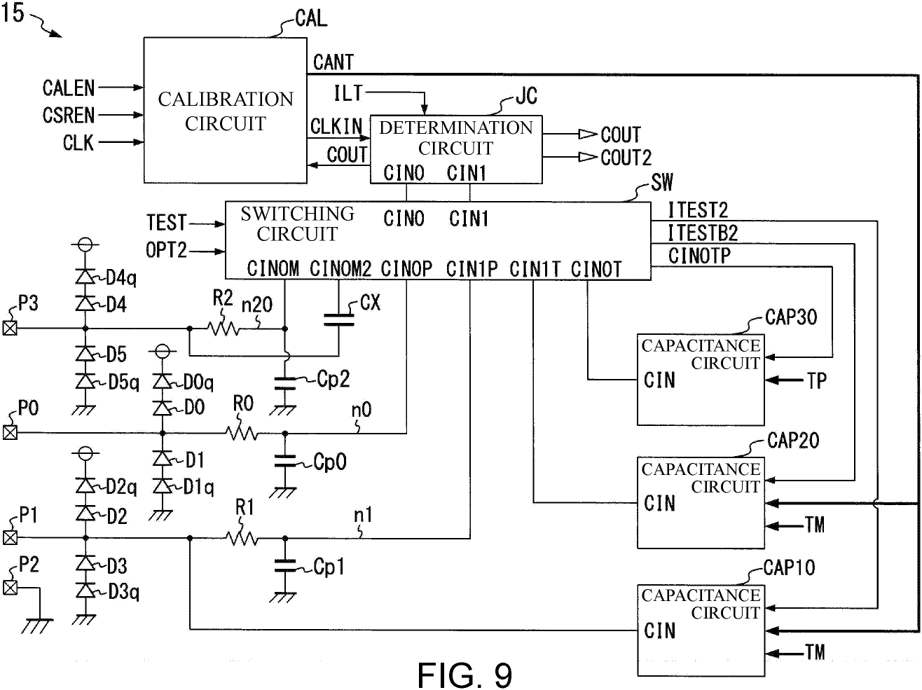

FIG. 9 is a block diagram illustrating a configuration of the capacitance sensor circuit 15.

As illustrated in FIG. 9, the capacitance sensor circuit 15 includes a calibration circuit CAL, a determination circuit JC, a switching circuit SW, an additional capacitor CX, a first capacitance circuit CAP10, a second capacitance circuit CAP20, and a third capacitance circuit CAP30.

Furthermore, the capacitance sensor circuit 15 includes first to third electrostatic breakdown protection circuits each having a configuration similar to the electrostatic breakdown protection circuits illustrated in FIGS. 1 to 3. The first to third electrostatic breakdown protection circuits are respectively connected to the electrode pads P0, P1 and P3 as the external terminals of the IC chip 100.

That is, the first electrostatic breakdown protection circuit includes diodes D0, D0q, D1, and D1q, a resistor R0, and a capacitor Cp0 illustrated in FIG. 9. The anode of the diode D0, the cathode of the diode D1, and one end of the resistor R0 are connected to the electrode pad P0. The anode of the diode D0q is connected to the cathode of the diode D0 and the cathode of the diode D0q is applied with the power supply voltage VDD via the power supply line. The cathode of the diode D1q is connected to the anode of the diode D1 and the anode of the diode D1q is applied with a ground voltage VSS via the ground line. Another end of the resistor R0 is connected to an input terminal CIN0P of the switching circuit SW via a node n0.

The second electrostatic breakdown protection circuit includes diodes D2, D2q, D3, and D3q, a resistor R1, and a capacitor Cp1 illustrated in FIG. 9. The anode of the diode D2, the cathode of the diode D3, and one end of the resistor R1 are connected to the electrode pad P1. The anode of the diode D2q is connected to the cathode of the diode D2 and the cathode of the diode D2q is applied with the power supply voltage VDD via the power supply line. The cathode of the diode D3q is connected to the anode of the diode D3 and the anode of the diode D3q is applied with the ground voltage VSS via the ground line. Another end of the resistor R1 is connected to an input terminal CIN1P of the switching circuit SW via a node n1.

The third electrostatic breakdown protection circuit includes diodes D4, D4q, D5, and D5q, a resistor R2, and a capacitor Cp2 illustrated in FIG. 9. The anode of the diode D4, the cathode of the diode D5, and one end of the resistor R2 are connected to the electrode pad P1. The anode of the diode D4q is connected to the cathode of the diode D4 and the cathode of the diode D4q is applied with the power supply voltage VDD via the power supply line. The cathode of the diode D5q is connected to the anode of the diode D5 and the anode of the diode D5q is applied with the ground voltage VSS via the ground line. Another end of the resistor R2 is connected to an input terminal CIN0M of the switching circuit SW via a node n20.

In addition, the diodes D0 to D5 and D0q to D5q may have the same cathode parasitic capacitance and anode parasitic capacitance. Further, the resistors R0 to R2 may also have the same resistance.

In the additional capacitor CX, one electrode of a pair of electrodes is connected to the electrode pad P3 and another electrode is connected to an input terminal CIN0M2 of the switching circuit SW. Additionally, as the additional capacitor CX, for example, a capacitor of any structure such as a Metal-Insulator-Metal (MIM) capacitor, a Metal Oxide Metal (MOM) capacitor, or a Metal Oxide Semiconductor (MOS) capacitor may be used.

A capacitance connection terminal CIN of the second capacitance circuit CAP20 is connected to an input terminal CIN1T of the switching circuit SW and a capacitance connection terminal CIN of the third capacitance circuit CAP30 is connected to an input terminal CINOT of the switching circuit SW.

The switching circuit SW receives a test mode signal TEST and a switching signal OPT2, each of which is binary (for example, ground potential and power supply potential) from the controller 14. Hereinafter, the higher potential of the binary will be referred to as an H level, and the lower potential will be referred to as an L level. The switching circuit SW sets the states of the input terminals CINOM, CIN0M2, CINOP, CIN1P, CIN1T, and CINOT based on the test mode signal TEST and the switching signal OPT2. Further, the switching circuit SW generates a binary test signal ITEST2, an inverted test signal ITESTB2, and a signal CINOTP based on the test mode signal TEST and the switching signal OPT2.

In addition, the test mode signal TEST is a signal having an H level when a test is performed to determine whether or not the detection operation and calibration (described later) by the capacitance sensor circuit 15 are normally performed and an L level otherwise in the IC chip 100 alone. Further, the switching signal OPT2 has an L level when connecting the sensor capacitor 50 between the electrode pads P2 and P0 of the IC chip 100 and has an H level when connecting the sensor capacitor between the electrode pads P2 and P3.

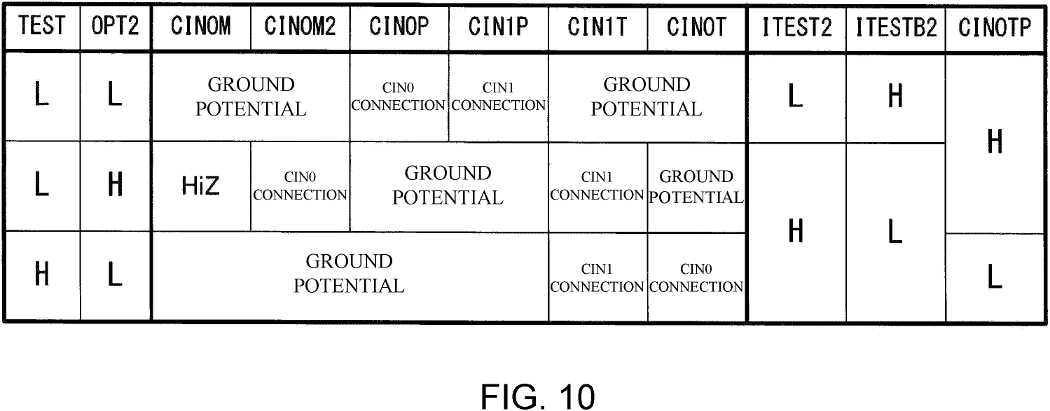

FIG. 10 is a diagram illustrating the operation of the switching circuit SW.

That is, the switching circuit SW sets the input terminals CINOM, CIN0M2, CIN1T, and CINOT to the ground potential state when both the test mode signal TEST and the switching signal OPT2 are at L level. Furthermore, at this time, the switching circuit SW connects the input terminal CIN0P to its first relay terminal CINO and connects the input terminal CIN1P to its second relay terminal CIN1.

Further, when the test mode signal TEST is at an L level and the switching signal OPT2 is at an H level, the switching circuit SW sets the input terminal CIN0M to a high impedance state and sets CINOP, CIN1P, and CINOT to a ground potential state. Furthermore, at this time, the switching circuit SW connects the input terminal CIN0M2 to the relay terminal CINO and connects the input terminal CIN1T to the relay terminal CIN1.

Further, when the test mode signal TEST is at an H level and the switching signal OPT2 is at an L level, the switching circuit SW sets the input terminals CINOM, CIN0M2, CINOP, and CIN1P to a ground potential state. Further, at this time, the switching circuit SW connects the input terminal CIN1T to the relay terminal CIN1 and connects the input terminal CINOT to the relay terminal CINO.

Further, the switching circuit SW generates the test signal ITEST2 having an H level when both the test mode signal TEST and the switching signal OPT2 are at an H level and having an L level when one of TEST and OPT2 is at an L level. The switching circuit SW supplies the test signal ITEST2 to the first capacitance circuit CAP10 and supplies an inverted test signal ITESTB2 obtained by inverting the level of the test signal ITEST2 (from an L level to an H level or from an H level to an L level) to the second capacitance circuit CAP20.

Further, the switching circuit SW generates the signal CINOTP having an L level when the test mode signal TEST is at an H level and the switching signal OPT2 is at an L level and having an H level otherwise. The switching circuit SW supplies the signal CINOTP to the third capacitance circuit CAP30.

The relay terminal CINO of the switching circuit SW is connected to the relay terminal CINO of the determination circuit JC and the relay terminal CIN1 of the switching circuit SW is connected to the relay terminal CIN1 of the determination circuit JC.

The determination circuit JC charges and discharges the sensor capacitor 50 via the relay terminal CINO, the node n0 (or n20), the resistor R0 (or R2), and the electrode pad P0 (or P3). Further, the determination circuit JC charges and discharges the capacitance circuit CAP10 via the relay terminal CIN1, the node n1, and the resistor R1. Further, the determination circuit JC charges and discharges the capacitance circuit CAP20 via the relay terminal CIN1. Further, the determination circuit JC charges and discharges the capacitance circuit CAP30 via the relay terminal CINO.

Then, the determination circuit JC compares the potential of the relay terminal CINO generated by charging and discharging the sensor capacitor 50 with the potential of the relay terminal CIN1 generated by charging and discharging the capacitance circuit CAP10 (or CAP20). At this time, the determination circuit JC determines whether or not the capacitance of the sensor capacitor 50 has changed from the first capacitance to the second capacitance based on the comparison result and supplies a detection signal COUT indicating the determination result to the calibration circuit CAL and the controller 14. Further, the determination circuit JC determines whether or not a difference between the potential of the relay terminal CINO and the potential of the relay terminal CIN1 is smaller than a predetermined value, that is, the two are substantially the same and supplies a flag signal COUT2 indicating the determination result to the controller 14.

Further, the determination circuit JC performs its leak test according to a leak test signal ILT supplied from the controller 14.

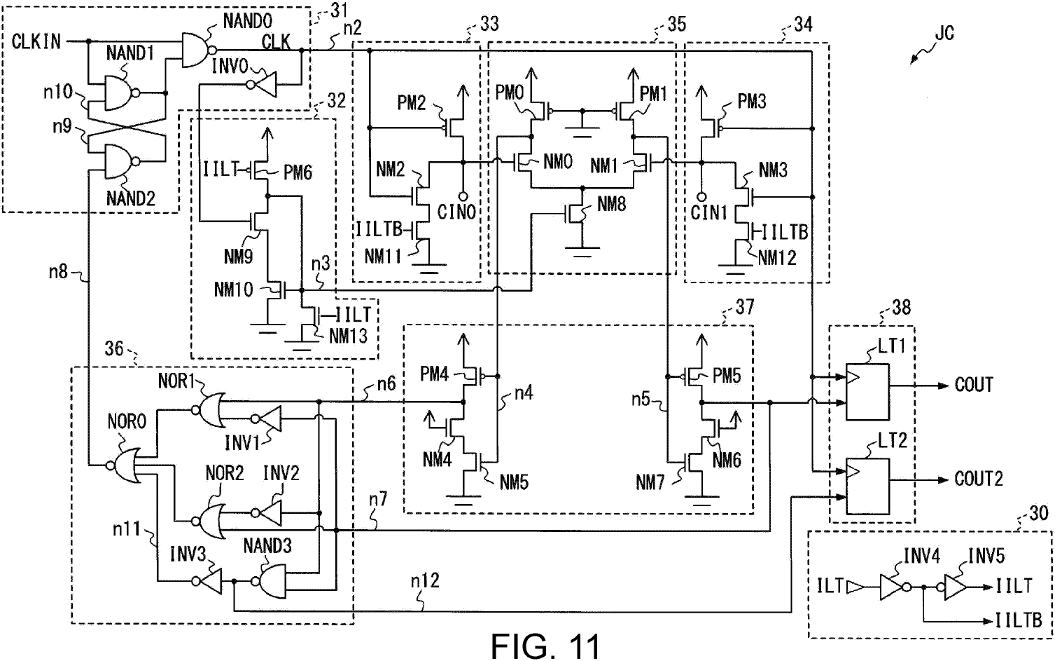

FIG. 11 is a circuit diagram illustrating a configuration of the determination circuit JC.

As illustrated in FIG. 11, the determination circuit JC includes a leak test reception unit 30, a control unit 31, a bias signal generation circuit 32, a first current supply unit 33, a second current supply unit 34, a differential amplifier unit 35, a timing generation circuit 36, an inverter unit 37, and a data latch unit 38.

The leak test reception unit 30 is composed of an inverter INV4 and an inverter INV5. The output end of the inverter INV4 is connected to the input end of the inverter INV5.

The inverter INV4 receives a leak test signal ILT at its input end and supplies a signal obtained by inverting the level to each of the current supply units 33 and 34 as an inverted signal IILTB while supplying the signal to the inverter INV5. The inverter INV5 supplies a signal obtained by inverting the level of the inverted signal IILTB to the bias signal generation circuit 32 as a control signal IILT.

The control unit 31 is composed of NAND0, NAND1, NAND2, and an inverter INV0.

The NAND0, NAND1, and NAND2 are 2-input NAND gate circuits that output NAND. The NAND0 receives a clock signal CLKIN at its one input end. The NAND1 and NAND2 form a flip-flop circuit. The NAND1 receives the clock signal CLKIN at its one input end. The output end of the NAND1 is connected to one input end of the NAND0. One input end of the NAND2 is connected to the other input end of the NAND0 together with the output end of the NAND1 via a node n9. The output terminal of the NAND2 is connected to the other input end of the NAND1 via a node n10. The NAND0 maintains an L level state while the output of the NAND1 is at an H level and outputs a signal obtained by inverting the level of the clock signal CLKIN to a node n2 as a clock signal CLK while the output of the NAND1 is at an L level. The input end of the inverter INV0 is connected to the output terminal of the NAND0 via the node n2. The inverter INV0 supplies a signal obtained by inverting the level of the output signal of the NAND0 input to the input end to the bias signal generation circuit 32 as an inverted clock signal.

The bias signal generation circuit 32 includes a transistor PM6, a transistor NM9, a transistor NM10, and a transistor NM13.

The transistor PM6 is composed of a P-channel MOSFET (Metal Oxide Semiconductor Field Effect Transistor). The source of the transistor PM6 is connected to the power supply and the drain is connected to a node n3. The transistor PM6 receives a control signal IILT at its gate. The transistors NM9, NM10, and NM13 are composed of N-channel MOSFETs which are second conductive transistors. The transistor NM9 receives the inverted clock signal output from the inverter INV0 at its gate. The drain of the transistor MN9 is connected to the node n3 and the source is connected to the drain of the transistor MN10. The source of the transistor NM10 is grounded and the gate is connected to the node n3. The transistor NM13 is composed of an N-channel MOSFET. The source of the transistor NM13 is grounded and the drain is connected to the node n3. The transistor NM13 receives the control signal IILT at its gate.

The current supply unit 33 includes transistors PM2, NM2, and NM11.

The transistor PM2 is composed of a P-channel MOSFET which is a first conductive transistor. The power supply is connected to the source of the transistor PM2 and the gate is connected to the node n2. The relay terminal CINO is connected to the drain of the transistor PM2. The transistors NM2 and NM11 are composed of N-channel MOSFETs which are second conductive transistors. The gate of the transistor NM2 is connected to the node n2 and the relay terminal CINO is connected to the drain. The drain of the transistor NM11 is connected to the source of the transistor NM2. The source of the transistor NM11 is grounded and receives the inverted signal IILTB at its gate.

The current supply unit 34 includes transistors PM3, NM3, and NM12.

The transistor PM3 is composed of a P-channel MOSFET which is a first conductive transistor. The power supply is connected to the source of the transistor PM3 and the gate is connected to the node n2. The relay terminal CIN1 is connected to the drain of the transistor PM3. The transistors NM3 and NM12 are composed of N-channel MOSFETs which are second conductive transistors. The gate of the transistor NM3 is connected to the node n2 and the relay terminal CIN1 is connected to the drain. The drain of the transistor NM12 is connected to the source of the transistor NM3. The source of the transistor NM12 is grounded and receives the inverted signal IILTB at its gate.

The differential amplifier unit 35 is a differential amplifier unit which amplifies and outputs a potential difference of the relay terminals CINO and CIN1. The differential amplifier unit 35 includes transistors PM0, PM1, NM0, NM1, and NM8.

The transistor PM0 and PM1 are composed of P-channel MOSFETs which are first conductive transistors. In the transistors PM0 and PM1, the sources are connected to the power supply and the gates are connected to each other and are grounded in common. The drain of the transistor PM0 is connected to a node n4 and the drain of the transistor NM0. The drain of the transistor PM1 is connected to a node n5 and the drain of the transistor NM1.

The transistors NM0, NM1, and NM8 are composed of N-channel MOSFETs which are second conductive transistors. The gate of the transistor NM0 is connected to the drain of the transistor PM2 and the drain of the transistor NM2 and is connected to the relay terminal CINO. The gate of the transistor NM1 is connected to the drain of the transistor PM3 and the drain of the transistor NM3 and is connected to the relay terminal CIN1.

In the transistor NM8, the source is grounded and the drain is connected to the sources of the transistors NM0 and NM1. The gate of the transistor NM8 is connected to the node n3 and is connected to the gate of the transistor NM10, the drain of the transistor PM6, and the drain of the transistor NM9 via the node n3. The transistor NM8 functions as a constant current source circuit. A constant current (tail current) sent by the transistor NM8 as a constant current source circuit is controlled by a bias signal from the bias signal generation circuit 32 (that is, the potential of the node n3).

The timing generation circuit 36 includes NORO, NOR1, NOR2, NAND3, an inverter INV1, an inverter INV2, and an inverter INV3.

The input end of the inverter INV1 is connected to a node n7. The inverter INV1 supplies an inverted signal obtained by inverting the level of the signal of the node n7 to the NOR1. The input end of the inverter INV2 is connected to a node n6. The inverter INV2 supplies an inverted signal obtained by inverting the level of the signal of the node n6 to the NOR2.

The NOR1 and NOR2 are 2-input NOR gate circuits that output NOR. One input end of the NOR1 is connected to the node n6 in common with the input end of the inverter INV2. The other input end of the NOR1 is connected to the output end of the inverter INV1. The NOR1 supplies the NOR signal of the signal of the node n6 and the inverted signal output from the inverter INV1 to the NORO.

One input end of the NOR2 is connected to the node n7 in common with the input end of the inverter INV1. The other input end of the NOR2 is connected to the output end of the inverter INV2. The NOR2 supplies the NOR signal of the signal of the node n7 and the inverted signal output from the inverter INV2 to the NORO.

The NAND3 is a 2-input NAND gate circuit that outputs NAND. One input end of the NAND3 is connected to the node n6. The other input end of the NAND3 is connected to the node n7. The NAND3 supplies a signal indicating the NAND of the signal on the node n6 and the signal on the node n7 to the inverter INV3 and supplies the signal to the data latch unit 38 via a node n12.

The inverter INV3 supplies a signal obtained by inverting the level of the signal output from the NAND3 to the NORO via a node n11.

The NORO is a 3-input NOR gate circuit that outputs NOR. The NORO supplies a signal indicating the NOR result of the signal output from each of the NOR1, the NOR2, and the inverter INV3 to the NAND2 of the control unit 31 via a node n8.

The inverter unit 37 is a circuit unit that inverts and outputs the output signal from the differential amplifier unit 35. The inverter unit 37 includes transistors PM4, PM5, NM4, NM5, NM6, and NM7.

The transistors PM4 and PM5 are composed of P-channel MOSFETs which are first conductive transistors and the transistors NM4 to NM7 are composed of N-channel MOSFETs which are second conductive transistors.

In the transistor PM4, the source is connected to the power supply and the gate is connected to the node n4. In the transistor NM4, the gate is connected to the power supply and the drain is connected to the node n6 in common with the drain of the transistor PM4. The transistor NM5 is composed of an N-channel MOSFET which is a second conductive transistor. In the transistor NM5, the source is grounded, the drain is connected to the source of the transistor NM4, and the gate is connected to the node n4.

In the transistor PM5, the source is connected to the power supply and the gate is connected to the node n5. In the transistor NM6, the gate is connected to the power supply and the drain is connected to the node n7 in common with the drain of the transistor PM5. In the transistor NM7, the source is grounded, the drain is connected to the source of the transistor NM6, and the gate is connected to the node n5.

By the configuration of the differential amplifier unit 35 and the inverter unit 37, a signal indicating whether or not the potential of the relay terminal CIN1 is larger than the potential of the relay terminal CINO is output to the node n6. Further, a signal indicating whether or not the potential of the relay terminal CINO is larger than the potential of the relay terminal CIN1 is output to the node n7.

Additionally, the transistors PM0 and PM1 are formed with the same dimensions (gate length, gate width, and the like). Similarly, the transistors PM2 and PM3, PM4 and PM5, NM0 and NM1, NM2 and NM3, NM4 and NM6, and NM5 and NM7 are each formed with the same dimensions.

The data latch unit 38 is composed of a first latch circuit LT1 and a second latch circuit LT2.

The clock signal CLK is supplied to the clock terminals of the latch circuits LT1 and LT2 via the node n2. The node n7 is connected to the signal input terminal of the latch circuit LT1 and the node n12 is connected to the signal input terminal of the latch circuit LT2.

The latch circuit LT1 acquires the signal of the node n7 while the clock signal CLK is at an L level.

Then, when the clock signal CLK transitions from an L level to an H level, the latch circuit LT1 outputs a signal obtained by inverting the signal level of the node n7 acquired immediately before as a detection signal COUT indicating whether or not the capacitance of the sensor capacitor 50 has changed from a first capacitance to a second capacitance lower than this first capacitance. Then, the latch circuit LT1 holds the acquired signal level and outputs the signal level as the detection signal COUT until the clock signal CLK transitions from an L level to an H level again.

The latch circuit LT2 acquires the signal of the node n12 while the clock signal CLK is at an L level. Then, when the clock signal CLK transitions from an L level to an H level, the latch circuit LT2 outputs a signal obtained by inverting the signal level of the node n12 acquired immediately before as a flag signal COUT2 indicating whether or not the potential of the relay terminal CINO is substantially the same as the potential of the relay terminal CIN1.

The calibration circuit CAL receives the detection signal COUT output from the determination circuit JC and receives a calibration enable signal CALEN, a sensor enable signal CSREN, and a clock signal CLK from the controller 14.

In addition, the calibration enable signal CALEN is a binary signal for switching a normal mode in which the determination circuit JC performs a normal operation and a calibration mode in which the determination circuit performs a calibration operation. For example, the calibration enable signal CALEN is at an H level in the calibration mode and is at an L level in the normal mode. The sensor enable signal CSREN is a signal for switching the capacitance sensor circuit 15 between an active state (normal mode state for performing a normal operation) and an inactive state (inactive mode state). For example, the sensor enable signal CSREN is in an inactive mode at an L level and is in a normal mode at an H level.

Further, the calibration circuit CAL supplies a binary clock signal CLKIN to the determination circuit JC in response to the clock signal CLK and the sensor enable signal CSREN.

Furthermore, the calibration circuit CAL supplies a control signal CANT of specifying the capacitance value of the reference capacitance of the capacitance circuit CAP10 or CAP20 or changing the capacitance value stepwise over time to the capacitance circuit CAP10 or CAP20 in response to CALEN, CSREN, CLK, and COUT.

The capacitance circuit CAP10 is a capacitor which provides a first reference capacitance for determining whether or not the capacitance of the sensor capacitor 50 is lower than a predetermined value when both electrodes of the sensor capacitor 50 are connected to the electrode pads P0 and P2.

The capacitance circuit CAP20 is a capacitor which provides a second reference capacitance for determining whether or not the combined capacitance of the sensor capacitor 50 and the additional capacitor CX is lower than a predetermined value when the sensor capacitor 50 is connected to the electrode pads P3 and P2.

The capacitance circuit CAP30 is used to test whether or not the detection operation and calibration (described later) by the capacitance sensor circuit 15 are normally performed in a state where the sensor capacitor 50 is not externally connected, that is, in the IC chip 100 alone. That is, the capacitance circuit CAP30 is a capacitor which provides a reference capacitance corresponding to the sensor capacitor 50 in the test.

In addition, the capacitance circuits CAP10, CAP20, and CAP30 are so-called variable capacitors capable of switching the capacitance value of the reference capacitance according to various control signals supplied from the controller or calibration circuit CAL.

The capacitance circuit CAP10 is set to the non-test mode when receiving the L-level test signal ITEST2 from the switching circuit SW and is set to the test mode when receiving the H-level test signal ITEST2. The capacitance circuit CAP20 is set to the non-test mode when receiving the L-level inverted test signal ITESTB2 from the switching circuit SW and is set to the test mode when receiving the H-level inverted test signal ITESTB2. The capacitance circuit CAP30 is set to the non-test mode when receiving the L-level signal CINOTP from the switching circuit SW and is set to the test mode when receiving the H-level signal CINOTP.

Hereinafter, the operation of the capacitance sensor circuit 15 will be described.

First, when the sensor capacitor 50 having a relatively small capacitance is used, one electrode W1 of the sensor capacitor 50 is connected to the electrode pad P0 of the IC chip 100 and another electrode W2 of the sensor capacitor 50 is connected to the electrode pad P2 as described above.

On the other hand, when the sensor capacitor 50 having a relatively large capacitance is used, one electrode W1 of the sensor capacitor 50 is connected to the electrode pad P3 of the IC chip 100 and another electrode W2 of the sensor capacitor 50 is connected to the electrode pad P2.

Then, the calibration circuit CAL performs a calibration process of automatically calibrating the capacitance corresponding to the capacitance of the sensor capacitor 50 externally connected to the IC chip 100 on the capacitance circuit CAP10 or CAP20 as a variable capacitor.

In addition, when the sensor capacitor 50 is connected to the electrode pad P0 and P2, only CAP10 of the capacitance circuits CAP10 and CAP20 is used as described above. On the other hand, when the sensor capacitor 50 is connected to the electrode pads P3 and P2, only the capacitance circuit CAP20 is used. At this time, since the calibration operation for each of the CAP10 and CAP20 is the same, the calibration operation performed for the CAP10 when the sensor capacitor 50 is connected to the electrode pads P0 and P2 will be extracted and described below.

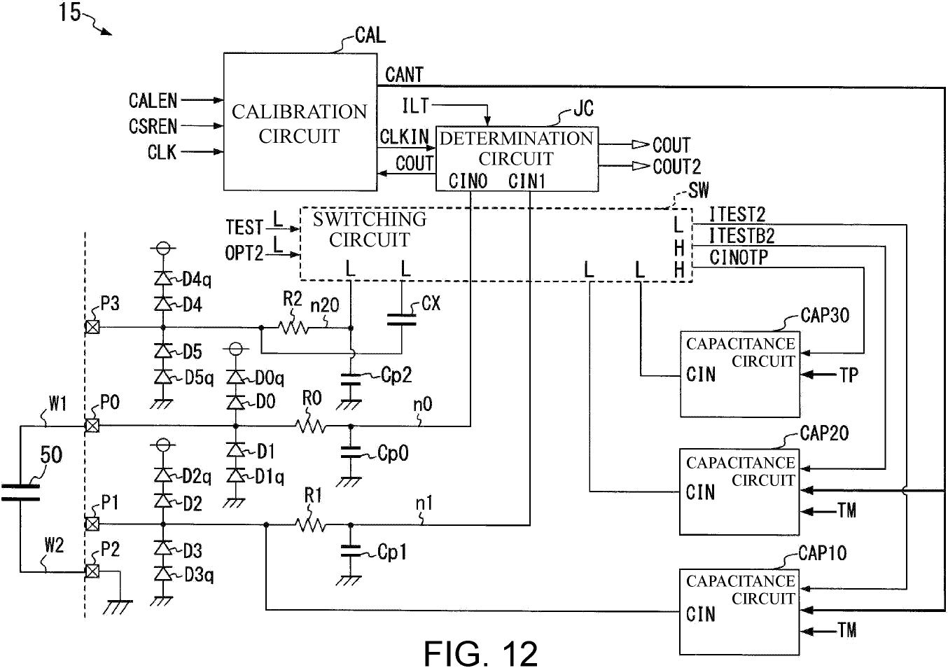

FIG. 12 is a block diagram describing the internal state of the capacitance sensor circuit 15 when the sensor capacitor 50 is connected to the electrode pads P0 and P2.

That is, when performing calibration, the controller 14 first supplies the L-level test mode signal TEST to the switching circuit SW and supplies the L-level leak test signal ILT to the determination circuit JC.

Furthermore, the controller 14 supplies the L-level switching signal OPT2 to the switching circuit SW and supplies the control signal CANT including information specifying the capacitance value of the reference capacitance of the capacitance circuit CAP10 to the capacitance circuit CAP10.

Accordingly, as illustrated in FIG. 12, the switching circuit SW connects the electrode W1 of the sensor capacitor 50 to the relay terminal CINO of the determination circuit JC via the node n0, the resistor R0, and the electrode pad P0. Further, the switching circuit SW connects the capacitance connection terminal CIN of the capacitance circuit CAP10 to the relay terminal CIN1 of the determination circuit JC via the node n1 and the resistor R1.

Furthermore, as illustrated in FIG. 12, the switching circuit SW applies an L level to the node n20, another end of the additional capacitor CX, and the capacitance connection terminal CIN of each of the capacitance circuits CAP20 and CAP30. Accordingly, since all capacitance connection terminals CIN of the capacitance circuit CAP30 and the capacitance circuit CAP20 are not connected to the determination circuit JC, there is no participation in the operation of the capacitance sensor circuit 15.

Hereinafter, the calibration operation performed by the calibration circuit CAL by the control from the controller 14 will be described.

First, the controller 14 supplies the L-level sensor enable signal CSREN and the calibration enable signal CALEN to the calibration circuit CAL.

Next, the controller 14 causes the sensor enable signal CSREN to transition from an L level to an H level. Accordingly, the capacitance sensor circuit 15 operates and outputs the detection signal COUT and the flag signal COUT2. For example, when the dielectric between the electrodes of the sensor capacitor 50 is in a solid state before melting and the capacitance value of the capacitance circuit CAP10 is smaller than that of the sensor capacitor 50, both signal levels of the detection signal COUT and the flag signal COUT2 are at an L level.

Then, the controller 14 causes the calibration enable signal CALEN to transition from an L level to an H level.

Over the period in which the calibration enable signal CALEN is at an H level, the calibration circuit CAL supplies the control signal CANT that changes the capacitance value of the capacitance of the capacitance circuit CAP10 stepwise over time to the capacitance circuit CAP10.

During this time, when the capacitance of the sensor capacitor 50 is larger than the capacitance of the capacitance circuit CAP10, the calibration circuit CAL supplies the control signal CANT that decreases the capacitance value of the capacitance circuit CAP10 to the capacitance circuit CAP10. On the other hand, when the capacitance of the sensor capacitor 50 is smaller than the capacitance of the capacitance circuit CAP10, the calibration circuit CAL supplies the control signal CANT that increases the capacitance of the capacitance circuit CAP10 to the capacitance circuit CAP10.

That is, the calibration circuit CAL performs a calibration process of changing the capacitance of the capacitance circuit CAP10 so that the reference capacitance of the capacitance circuit CAP10 is the same as the capacitance of the sensor capacitor 50 in a solid state.

Here, when the determination circuit JC determines that the potential of the first relay terminal CINO is the same as the potential of the second relay terminal CIN1 during this calibration process, the controller 14 stores information indicating the capacitance value specified by the calibration circuit CAL at that time point in the nonvolatile memory 16 as second trimming information.

Then, when the power supply is cut off and then turned on again, the controller 14 reads the second trimming information from the memory 16 and supplies the second trimming information to the calibration circuit CAL as first trimming information.

Then, the controller 14 sets the capacitance sensor circuit 15 in the normal operation mode by causing the sensor enable signal CSREN to transition from an L level to an H level and supplying the L-level calibration enable signal CALEN to the calibration circuit CAL.

Thus, in the normal operation mode, the capacitance of the capacitance circuit CAP10, that is, the first reference capacitance is set to a capacitance value between a first capacitance before the melting of the dielectric of the sensor capacitor 50 including the parasitic capacitance outside the IC chip 100 and a second capacitance after the melting of the dielectric.

Through this series of calibrations, the capacitance of the capacitance circuit CAP10 is set to an intermediate level between the capacitance before the melting of the dielectric of the sensor capacitor 50 and the capacitance after the melting.

Accordingly, it is possible to accurately determine whether or not the dielectric filled between the electrodes of the sensor capacitor 50 has melted as the ambient temperature to which the sensor capacitor 50 is exposed changes after calibration.

Then, the controller 14 sets the capacitance value of the reference capacitance of the capacitance circuit CAP10 by the control signal TM indicating the second trimming information stored in the memory 16 when the power is turned on next time.

In addition, in the above-described embodiment, the calibration circuit CAL is used to calibrate the capacitance circuit CAP10 (or CAP20, CAP30) to a reference capacitance that serves as a threshold for detecting changes in the capacitance of the sensor capacitor 50.

However, the calibration operation by the calibration circuit CAL can be used to detect the capacitance of the capacitor connected to the electrode pads P0 (or P3) and P2. For example, the capacitor whose capacitance is to be detected is connected to the electrode pads P0 (or P3) and P2, and the above-described calibration operation is executed. At this time, when the determination circuit JC outputs the H-level flag signal COUT2, the second trimming information output by the calibration circuit CAL at that time is acquired by the controller 14. That is, the second trimming information acquired by the controller 14 at the time point in which the H-level flag signal COUT2 is output indicates the reference capacitance of the capacitance circuit CAP10 and the value is the same as the capacitance of the capacitor connected to the electrode pads P0 (or P3) and P2.

Here, the controller 14 supplies information indicating the capacitance corresponding to the acquired second trimming information to the transmitting/receiving circuit 13 as transmission information together with the identification ID. Accordingly, the sensor tag 150 wirelessly sends the identification ID and the information indicating the capacitance of the capacitor connected to the electrode pads P0 (or P3) and P2 to the reader/writer 200 as illustrated in FIG. 7. Thus, the reader/writer 200 can acquire the capacitance of the capacitors connected to the electrode pads P0 (or P3) and P2 of the sensor tag 150 by wireless communication.

As described above, in the capacitance sensor circuit 15, when the dielectric between the electrodes of the externally connected sensor capacitor 50 has not yet melted, the determination circuit JC outputs the L-level detection signal COUT and the L-level flag signal COUT2. When the dielectric melts to some extent and the capacitances of the sensor capacitor 50 and the capacitance circuit CAP10 become substantially equal, the determination circuit JC outputs the L-level detection signal COUT and the H-level flag signal COUT2. Then, when the dielectric is completely melted, the determination circuit JC outputs the H-level detection signal COUT and the L-level flag signal COUT2.

Thus, according to the capacitance sensor circuit 15, it is possible to obtain information (COUT) indicating whether or not the dielectric of the externally connected sensor capacitor 50 has melted, that is, the capacitance of the sensor capacitor 50 has changed. Further, according to the capacitance sensor circuit 15, it is possible to obtain information (COUT2) indicating whether or not the sensor capacitor 50 and the capacitance circuit CAP10 have substantially the same capacitance.

In addition, as described above, when the sensor capacitor 50 having a relatively large capacitance is externally connected to the electrode pads P2 and P3, the calibration operation and the capacitance detection process can be performed as in the case of using the capacitance circuit CAP10 by using the capacitance circuit CAP20.

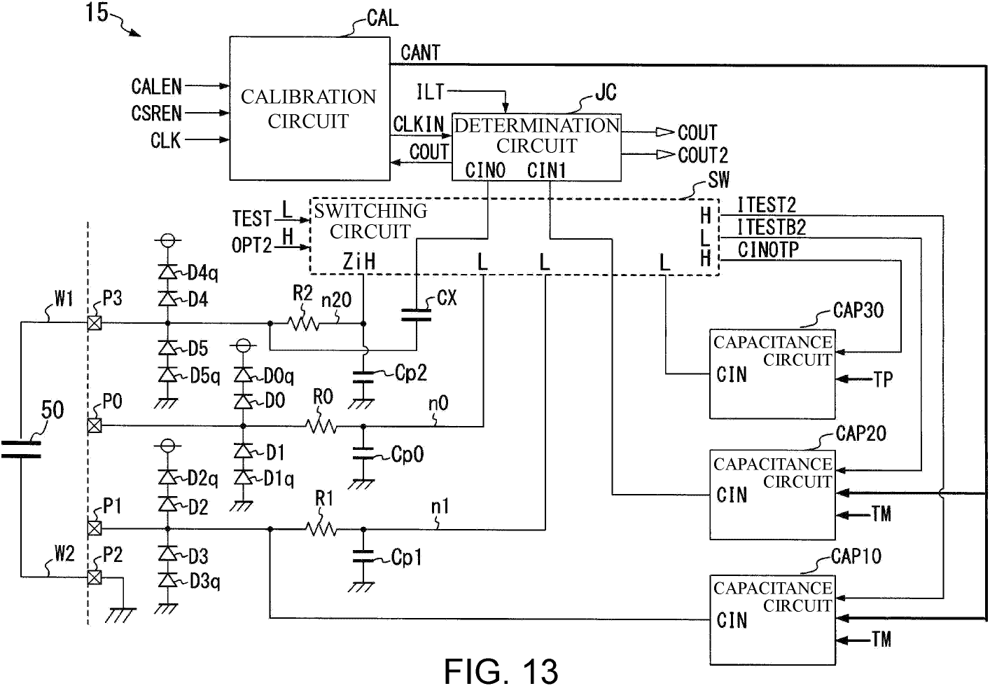

FIG. 13 is a block diagram describing the internal state of the capacitance sensor circuit 15 when both electrodes of the sensor capacitor 50 having a relatively large capacitance are connected to the electrode pads P2 and P3.

At this time, the controller 14 supplies the L-level test mode signal TEST to the switching circuit SW and supplies the L-level leak test signal ILT to the determination circuit JC. Further, the controller 14 supplies the H-level switching signal OPT2 to the switching circuit SW and supplies the control signal CANT including information specifying the capacitance value of the reference capacitance of the capacitance circuit CAP20 to the capacitance circuit CAP20.

Accordingly, as illustrated in FIG. 13, the switching circuit SW connects the electrode W1 of the sensor capacitor 50 to the relay terminal CINO of the determination circuit JC via the additional capacitor CX and the electrode pad P3. Further, the switching circuit SW connects the capacitance connection terminal CIN of the capacitance circuit CAP20 to the relay terminal CIN1 of the determination circuit JC.

Furthermore, as illustrated in FIG. 13, the switching circuit SW sets the node n20 to a high impedance (denoted as HiZ) state and applies an L level to the nodes n0 and n1 and the capacitance connection terminal CIN of the capacitance circuit CAP30.

Incidentally, in the determination circuit JC, the sensor capacitor 50 is charged when the potential of the electrode of the sensor capacitor 50 is compared with the potential of the capacitance connection terminal CIN of the capacitance circuit CAP20.

At this time, when the capacitance of the sensor capacitor 50 is large, current consumption for the charging operation is large compared to when the capacitance is small. Further, when the speed of charging the sensor capacitor 50 and the parasitic capacitance outside the IC chip 100 is fast, the power supply voltage generated by the power supply circuit 12 may drop and cause malfunction.

Here, in the capacitance sensor circuit 15, the additional capacitor CX is provided to be connected in series with the sensor capacitor 50 between the electrode pad P3 connecting one electrode W1 of the sensor capacitor 50 having a relatively large capacitance and the input terminal CIN0M2 of the switching circuit SW.

The determination circuit JC supplies the charging current sent from its relay terminal CINO to the additional capacitor CX and supplies the charging current sent from the relay terminal CIN1 to the capacitance circuit CAP20. Accordingly, the additional capacitor CX and the sensor capacitor 50 connected in series via the electrode pad P3 are charged as the capacitance circuit CAP20 is charged.

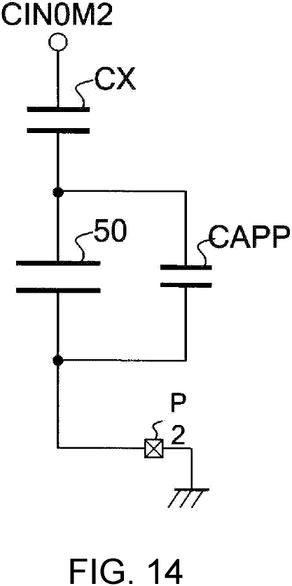

Here, a circuit included between the electrode pad P2 and the input terminal CIN0M2 of the switching circuit SW is represented by an equivalent circuit illustrated in FIG. 14. In addition, CAPP illustrated in FIG. 14 indicates the combined parasitic capacitance obtained by combining the parasitic capacitances of the diodes D4, D4q, D5, and D5q, the resistor R2, and the electrode pad P3 illustrated in FIG. 13.

Thus, in the equivalent circuit illustrated in FIG. 14, the combined capacitance CAPT viewed from the input terminal CIN0M2 of the switching circuit SW is represented by CAPT= (CAP1+CAP2)•CAP2/(CAP1+CAPP+CAP2) (CAP1: capacitance of sensor capacitor 50, CAP2: capacitance of additional capacitor CX, and CAPP: combined parasitic capacitance of P3, R2, D4, D4q, D5, D5q).

Accordingly, even when the capacitance CAP1 of the sensor capacitor 50 is large, the combined capacitance CAPT can be decreased by decreasing the capacitance CAP2 of the additional capacitor CX connected in series therewith.

Thus, even when the capacitance CAP1 of the sensor capacitor 50 externally connected to the IC chip 100 is relatively large, it is possible to perform the above-described calibration and capacitance detection process without increasing the current consumed for charging the combined capacitance CAPT.

Next, a test operation for internally verifying whether or not the detection operation and calibration by the capacitance sensor circuit 15 described above are normally performed in the IC chip 100 alone will be described.

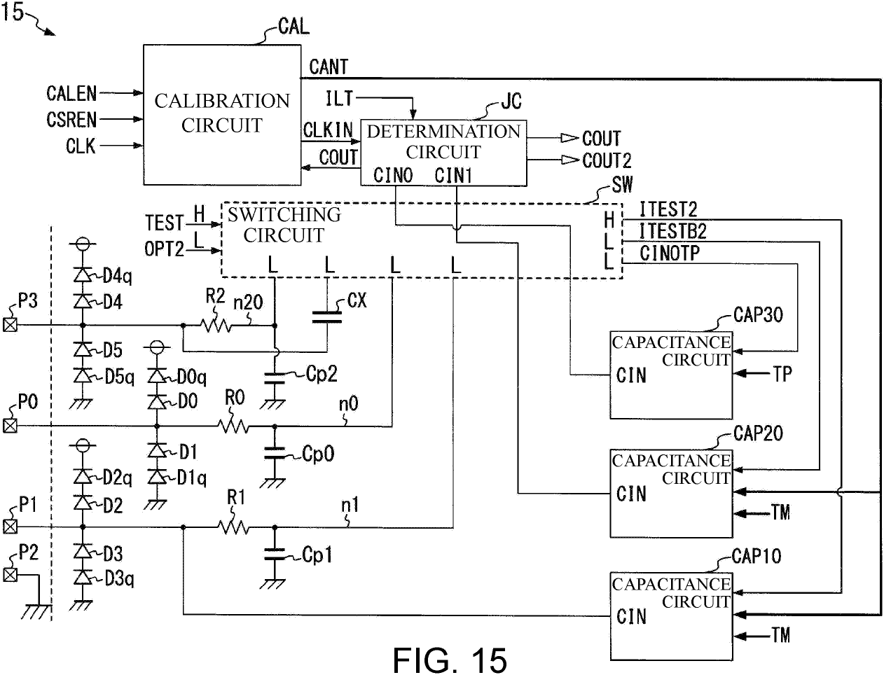

FIG. 15 is a block diagram describing the internal state of the capacitance sensor circuit 15 in the test mode in which such an internal verification test is performed.

When performing the internal verification test, the controller 14 supplies the H-level test mode signal TEST and the L-level switching signal OPT2 to the switching circuit SW and supplies the L-level leak test signal ILT to the determination circuit JC.

Accordingly, as illustrated in FIG. 15, the switching circuit SW connects the capacitance connection terminal CIN of the capacitance circuit CAP30 to the relay terminal CINO of the determination circuit JC and connects the capacitance connection terminal CIN of the capacitance circuit CAP20 to the relay terminal CIN1 of the determination circuit JC. Further, the switching circuit SW supplies the H-level test signal ITEST2 to the capacitance circuit CAP10, supplies the L-level inverted test signal ITESTB2 to the capacitance circuit CAP20, and supplies the L-level signal CINOTP to the capacitance circuit CAP30.

Here, for example, the controller 14 supplies the capacitance circuit CAP30 with a control signal TP for setting a capacitance value that is half the difference between the capacitance before the melting of the dielectric of the sensor capacitor 50 and the capacitance after the melting of the dielectric as the reference capacitance of the capacitance circuit CAP30. Accordingly, the capacitance of the capacitance circuit CAP30, that is, the capacitance value of the third reference capacitance is set to the capacitance value of the difference between the capacitance before the melting of the dielectric of the sensor capacitor 50 and the capacitance after the melting of the dielectric.

In this state, the calibration circuit CAL performs the above-described calibration until the capacitance of the capacitance circuit CAP20 becomes the same as the capacitance of the capacitance circuit CAP30.

Then, the controller 14 decreases the capacitance of the capacitance circuit CAP20 by a predetermined capacitance value so that the capacitance of the capacitance circuit CAP20 is set to a value obtained by subtracting the capacitance corresponding to half the difference between the capacitance before the melting of the dielectric of the sensor capacitor 50 and the capacitance after the melting of the dielectric from the capacitance of the capacitance circuit CAP30.

Accordingly, it is possible to verify the operation of the capacitance sensor circuit 15 while the capacitance of the capacitance circuit CAP20 is smaller than the capacitance of the capacitance circuit CAP30 by the capacitance corresponding to half the difference between the capacitance before the melting of the dielectric of the sensor capacitor 50 and the capacitance after the melting of the dielectric.

Further, the controller 14 decreases the capacitance of the capacitance circuit CAP30 by a predetermined capacitance value so that the capacitance of the capacitance circuit CAP30 is set to a value obtained by subtracting the capacitance corresponding to half the difference between the capacitance before the melting of the dielectric of the sensor capacitor 50 and the capacitance after the melting of the dielectric from the capacitance of the capacitance circuit CAP20.

Accordingly, it is possible to verify the operation of the capacitance sensor circuit 15 while the capacitance of the capacitance circuit CAP30 is smaller than the capacitance of the capacitance circuit CAP20 by the capacitance corresponding to half the difference between the capacitance before the melting of the dielectric of the sensor capacitor 50 and the capacitance after the melting of the dielectric.

In this way, according to the capacitance sensor circuit 15 of this embodiment, it is possible to verify whether or not the above-described calibration operation and detection operation are performed correctly in a state where the sensor capacitor 50 to be detected is not externally connected to the IC chip 100, for example, at the wafer stage of the IC chip 100.

Next, the leak test mode of the capacitance sensor circuit 15 will be described.

In the leak test mode, the controller 14 supplies the H-level leak test signal ILT to the determination circuit JC. At this time, the inverted signal IILTB of the determination circuit JC illustrated in FIG. 11 is at an L level and the control signal IILT is at an H level.

Accordingly, the transistor PM6 illustrated in FIG. 11 is turned off when the H-level control signal IILT is supplied to its gate. The transistor NM13 is turned on when the H-level control signal IILT is supplied to the gate.

The transistor NM11 is turned off when the L-level inverted signal IILTB is supplied to the gate. Similarly, the transistor NM12 is turned off when the L-level inverted signal IILTB is supplied to the gate.

Accordingly, both the node n0 and the node n1 illustrated in FIG. 9 are in a high impedance state. Further, the potential of the node n3 illustrated in FIG. 11 is at an L level.

When the potential of the node n3 is at an L level, the transistor NM8 is turned off. Therefore, a through current does not flow between the bias signal generation circuit 32 and the differential amplifier unit 35. The period in this state is the leak test mode.

In this way, in the leak test mode, the controller 14 can set the node n0 or n20 connected to the sensor capacitor 50 and the node n1 connected to the capacitance circuit CAP10 in a high impedance state by supplying the H-level leak test signal ILT to the determination circuit JC. Thus, it is possible to perform a screening test for detecting a short circuit failure or the like of the electrode pad P0 or P3 in the test process after manufacturing the IC chip 100.

In addition, as the switching circuit SW of the above-described embodiment, any circuit configuration may be adopted if the operation illustrated in FIG. 10 can be performed.

Further, in the above-described embodiment, the electrode pad (P0, P3) connecting one electrode W1 of the sensor capacitor 50 is individually provided for the case in which the sensor capacitor having a relatively large or small capacitance is used as the sensor capacitor 50 externally connected to the IC chip 100. However, this may be referred to as a common electrode pad. At this time, for example, a switch connected to the common electrode pad is provided inside the IC chip 100 and the connection target of the common electrode pad is switched to one end of the resistor R2 or one end of the resistor R0 by the switch.

In short, the capacitance sensor device (15, 100) according to the disclosure may include the first and second external terminals, the additional capacitor, the first and second electrostatic breakdown protection circuits, the first and second capacitance circuits, the determination circuit, and the calibration circuit together with the sensor capacitor (50) of which the capacitance changes in response to environmental changes.

The first external terminal (P0) and the second external terminal (P3) are terminals to which the electrode of the sensor capacitor (50) is externally attached and the sensor capacitor is externally attached to any one of them.

In the additional capacitor (CX), one electrode of the pair of electrodes is connected to the second external terminal (P3).

The first capacitance circuit (CAP10) is a variable capacitance circuit having a first reference capacitance whose capacitance value is variable and the second capacitance circuit (CAP20) is a variable capacitance circuit having a second reference capacitance whose capacitance value is variable.

The determination circuit (JC, SW) includes the first and second relay terminals (CINO, CIN1) and supplies a charging current from the first relay terminal (CINO) to the sensor capacitor (50) via the first electrostatic breakdown protection circuit (D0, D0q, D1, D1q, R0, Cp0) and the first external terminal (P0). Further, the determination circuit (JC, SW) supplies a charging current from the second relay terminal (CIN1) to the first capacitance circuit (CAP10) and then compares a magnitude of the potential of the first relay terminal (CINO) with a magnitude of the potential of the second relay terminal (CIN1) to detect the capacitance of the sensor capacitor or detect whether there is a change in the capacitance of the sensor capacitor.

Further, the determination circuit (JC, SW) supplies a charging current from the first relay terminal (CINO) to the sensor capacitor (50) via the second electrostatic breakdown protection circuit (D4, D4q, D5, D5q, R2, Cp2) and the second external terminal (P3). Further, the determination circuit (JC, SW) supplies a charging current from the second relay terminal (CIN1) to the second capacitance circuit (CAP20) and then compares a magnitude of the potential of the first relay terminal (CINO) with a magnitude of the potential of the second relay terminal (CIN1) to detect the capacitance of the sensor capacitor or detect whether there is a change in the capacitance of the sensor capacitor.

The calibration circuit (CAL) performs a calibration process of changing the capacitance value of the first reference capacitance or the second reference capacitance stepwise over time on the first capacitance circuit (CAP10) or the second capacitance circuit (CAP20), so that the capacitance value of the first reference capacitance or the second reference capacitance is substantially the same as the capacitance value of the sensor capacitor.

The first electrostatic breakdown protection circuit includes the following first to fourth diodes. That is, the first electrostatic breakdown protection circuit includes the first diode (D0) of which the anode is connected to the first external terminal (P0) and the second diode (D0q) of which the cathode receives the power supply voltage (VDD) and the anode is connected to the cathode of the first diode. Further, the first electrostatic breakdown protection circuit includes the third diode (D1) of which the cathode is connected to the first external terminal (P0) and the fourth diode (D1q) of which the anode receives the ground voltage (VSS) and the cathode is connected to the anode of the third diode.

The second electrostatic breakdown protection circuit includes the following fifth to eighth diodes. That is, the second electrostatic breakdown protection circuit includes the fifth diode (D4) of which the anode is connected to the second external terminal (P3) and the sixth diode (D4q) of which the cathode receives the power supply voltage (VDD) and the anode is connected to the cathode of the fifth diode. Further, the second electrostatic breakdown protection circuit includes the seventh diode (D5) of which the cathode is connected to the second external terminal (P3) and the eighth diode (D5q) of which the anode receives the ground voltage (VSS) and the cathode is connected to the anode of the seventh diode.

Thus, in the capacitance sensor device (15, 100) including the first and second electrostatic breakdown protection circuits, when a high surge voltage accompanying electrostatic discharge is applied to the external terminals (P0, P3), a current corresponding to the surge voltage flows into the power supply line or the ground line via a diode group (D0, D0q, D1, D1q, D4, D4q, D5, D5q). Accordingly, since the amount of the current flowing into the capacitance sensor circuit 15 due to electrostatic discharge is greatly suppressed, the capacitance sensor circuit 15 is protected from electrostatic breakdown.

In addition, when the capacitance sensor device is brought close to a communication device (reader/writer or the like) that operates according to ISO/IEC18000-6 Type-C which is a short-range wireless communication standard, electromagnetic wave noise emitted from the communication device is applied to the external terminal (P0, P3).

Here, in the first and second electrostatic breakdown protection circuits, since a series diode group in which two diodes are connected in series as a diode circuit connected between the external terminal and the power supply line (ground line) is adopted, it is possible to increase the threshold voltage (Vth1, Vth2) for flowing a current between the external terminal and the power supply line (the ground line).

Accordingly, since the capacitance sensor device (15, 100) is brought close to the communication device conforming to the short-range wireless communication standard, it is possible to prevent a current accompanying electromagnetic wave noise from flowing to the power supply line or the ground line even when electromagnetic wave noise emitted from the communication device is applied to the external terminal (P0, P3).

Thus, since charges accompanying electromagnetic wave noise are not accumulated in the external terminals, the capacitance value of the capacitor (50) externally attached to the external terminals does not fluctuate. Thus, according to the first and second electrostatic breakdown protection circuits, the capacitance sensor circuit (15) connected to the external terminal (P0, P3) can accurately detect the detection errors of the capacitance of the capacitor (50) or changes in the capacitance of the capacitor.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An electrostatic breakdown protection circuit included in an electronic device including an external terminal and an internal circuit connected to the external terminal, the electrostatic breakdown protection circuit comprising:
a first series diode group in which n diodes including a first diode having an anode connected to the external terminal and a second diode having a cathode applied with a power supply voltage are connected in series, where n is an integer equal to or larger than 2; and
a second series diode group in which n diodes including a third diode having a cathode connected to the external terminal and a fourth diode having an anode applied with a ground voltage are connected in series.

2. The electrostatic breakdown protection circuit according to claim 1, further comprising:
a resistor of which one end is connected to the external terminal and another end is connected to the internal circuit; and
a capacitor of which one electrode is connected to the another end of the resistor and another electrode is applied with the ground voltage.

3. The electrostatic breakdown protection circuit according to claim 1,
wherein the external terminal is a terminal to which an electrode of a capacitor is externally attached from outside of the electronic device.

4. The electrostatic breakdown protection circuit according to claim 1,
wherein the first series diode group includes the first diode and the second diode of which an anode is connected to a cathode of the first diode, and
wherein the second series diode group includes the third diode and the fourth diode of which a cathode is connected to an anode of the third diode.

5. The electrostatic breakdown protection circuit according to claim 4,
wherein the electronic device is a semiconductor device,
wherein the first diode is a first MOS transistor of which a source is connected to the external terminal and a gate is applied with the power supply voltage,
wherein the second diode is a second MOS transistor of which a source is connected to a drain of the first MOS transistor and a drain and a gate are applied with the power supply voltage,
wherein the third diode is a third MOS transistor of which a source is connected to the external terminal and a gate is applied with the ground voltage, and
wherein the fourth diode is a fourth MOS transistor of which a source is connected to a drain of the third MOS transistor and a drain and a gate are applied with the ground voltage.

6. The electrostatic breakdown protection circuit according to claim 1,
wherein the electronic device includes a communication circuit that performs wireless communication conforming to a short-range wireless communication standard.

7. The electrostatic breakdown protection circuit according to claim 6,
wherein the electronic device is an IC tag that receives power wirelessly.

8. A capacitance sensor device, comprising:
a sensor capacitor of which a capacitance changes according to changes in an environment;
a first external terminal to which an electrode of the sensor capacitor is externally attached;
a first electrostatic breakdown protection circuit which is connected to the first external terminal;
a first capacitance circuit which has a first reference capacitance; and
a determination circuit which includes a first relay terminal and a second relay terminal, supplies a charging current from the first relay terminal to the sensor capacitor via the first electrostatic breakdown protection circuit and the first external terminal, supplies a charging current from the second relay terminal to the first capacitance circuit, and then compares a magnitude of a potential of the first relay terminal with a magnitude of a potential of the second relay terminal to detect the capacitance of the sensor capacitor or detect whether there is a change in the capacitance of the sensor capacitor,
wherein the first electrostatic breakdown protection circuit includes:
a first diode of which an anode is connected to the first external terminal,
a second diode of which a cathode receives a power supply voltage and an anode is connected to a cathode of the first diode,
a third diode of which a cathode is connected to the first external terminal, and
a fourth diode of which an anode receives a ground voltage and a cathode is connected to an anode of the third diode.

9. The capacitance sensor device according to claim 8, further comprising:
a second external terminal to which an electrode of the sensor capacitor is externally attached;
a second electrostatic breakdown protection circuit which is connected to the second external terminal;
an additional capacitor in which one electrode of a pair of electrodes is connected to the second external terminal; and
a second capacitance circuit which has a second reference capacitance,
wherein the determination circuit sends a charging current from the first relay terminal to another electrode of the additional capacitor to supply the charging current to the sensor capacitor via the additional capacitor, the second electrostatic breakdown protection circuit, and the second external terminal, sends a charging current from the second relay terminal to the second capacitance circuit, and then compares a magnitude of a potential of the first relay terminal with a magnitude of a potential of the second relay terminal to detect the capacitance of the sensor capacitor or detect whether there is a change in the capacitance of the sensor capacitor, and
wherein the second electrostatic breakdown protection circuit includes:
a fifth diode of which an anode is connected to the second external terminal,
a sixth diode of which a cathode receives the power supply voltage and an anode is connected to a cathode of the fifth diode,
a seventh diode of which a cathode is connected to the second external terminal, and
an eighth diode of which an anode receives the ground voltage and a cathode is connected to an anode of the seventh diode.

10. The capacitance sensor device according to claim 9,
wherein a capacitance value of the reference capacitance of each of the first capacitance circuit and the second capacitance circuit is variable, and
wherein the capacitance sensor device further comprises a calibration circuit which performs a calibration process of changing a capacitance value of the first reference capacitance or the second reference capacitance stepwise over time on the first capacitance circuit or the second capacitance circuit, so that the capacitance value of the first reference capacitance or the second reference capacitance is substantially the same as a capacitance value of the sensor capacitor.
